(19) United States
(12) Patent Application Publication
(10) Pub. No.: US 2026/0187147 A1
(43) Pub. Date: Jul. 2, 2026

(54) EDGE-ENABLED SYSTEM FOR SMART VIDEO PROCESSING, VECTORIZED OBJECT DETECTION, SEARCH, AND CUSTOMIZABLE ALERTS USING SMART NVR DEVICES

(71) Applicant: AGI7 Inc., San Jose, CA (US)

(72) Inventor: Song Cao, San Jose, CA (US)

(21) Appl. No.: 19/427,414

(22) Filed: Dec. 19, 2025

Related U.S. Application Data
(60) Provisional application No. 63/737,064, filed on Dec. 20, 2024.

(51) Int. Cl. G06F 16/783; G06F 16/738; G06V 10/74; G06V 20/52; G06V 20/70

(52) U.S. Cl. CPC G06F 16/7837; G06F 16/738; G06V 10/761; G06V 20/52; G06V 20/70

(57) ABSTRACT

An edge-enabled video surveillance system supports semantic search over large volumes of camera footage. Network video recorders (NVRs) receive video streams from multiple cameras, perform on-device analysis to detect objects and events, and generate machine-readable representations including attribute data and textual descriptions. The NVRs convert these representations into vectorized embeddings and transmit the embeddings with temporal and spatial metadata to a cloud-hosted vector database. A cloud-based server receives natural-language or multimodal user queries, uses a language model to generate corresponding query embeddings, and executes a multi-level iterative similarity search over the vector database to progressively filter candidate embeddings. Video segments that are semantically relevant to the query are identified and presented together with associated timestamps and location information, enabling intuitive, low-latency retrieval, visualization, and alerting across distributed camera deployments.

### CROSS-REFERENCE TO RELATED APPLICATIONS

This application claims the benefit of U.S. Provisional Application No. 63/737,064, filed Dec. 20, 2024, and entitled “EDGE-ENABLED SYSTEM FOR SMART VIDEO PROCESSING, VECTORIZED OBJECT DETECTION, SEARCH, AND CUSTOMIZABLE ALERTS USING SMART NVR DEVICES,” the entire disclosure of which is hereby incorporated by reference in its entirety.

### TECHNICAL FIELD

The present invention relates generally to video surveillance systems and, more particularly, to a system involving smart Network Video Recorders (NVRs) that collect video streams, perform edge computation for object detection and vectorization, enable natural language search, and provide customizable user-defined alerts without requiring extensive training.

### BACKGROUND

Traditional video surveillance systems rely heavily on pre-defined alerts and rules for event or object detection. These alerts typically demand extensive model training and configuration to detect specific objects or events, such as detecting human movement or identifying vehicles. Such systems inherently lack flexibility, as users cannot easily customize their criteria for event detection or conduct sophisticated, ad-hoc searches. In addition, the outputs of object detection—when present at all—are often stored in rudimentary or unstructured formats. Existing solutions may rely on minimal tagging of video streams, such as noting the presence of motion or annotating basic timestamps. While this approach can facilitate the storage and retrieval of clips associated with predefined alerts, it falls short when users attempt to search for events or objects that were not anticipated or modeled in advance.

For instance, conventional systems might detect motion and then tag and store corresponding video clips for later review. However, these tags provide only limited metadata, typically describing generic categories like “motion” or “vehicle present.” Consequently, if a user wants to search for a red vehicle with a specific plate number or a person wearing particular clothing and performing a certain action, these systems cannot support the query. Their predefined labels are simply not rich or granular enough to capture complex, user-defined criteria. The result is that users are restricted to either searching through footage manually or depending on predetermined alerts and tags that do not account for nuanced or evolving investigative needs.

The present invention addresses these limitations by introducing a smart NVR-based system capable of edge computation, vectorizing object attributes as they are detected, and enabling natural language-based search. By converting object attributes into high-dimensional vector representations and storing them in a structured, searchable format, the system supports flexible, on-the-fly queries without requiring extensive retraining or reconfiguration of underlying models. Users can define their own alerts and search criteria in natural language, and the system matches these queries to vectorized object attributes in real time, enabling truly adaptive and comprehensive video surveillance analysis.

### BRIEF DESCRIPTION OF THE DRAWINGS

FIGS. 1A-1D illustrate example searches of objects in videos indexed and stored by the edge-enabled smart video system.

FIG. 1E illustrates an example configuration of the NVR devices for embedding videos collected on the edge cameras.

FIG. 2A illustrates the edge-enabled smart video system adopting AI-powered cloud-native NVR devices, in accordance with some embodiments.

FIG. 2B illustrates a workflow for processing a user query in the edge-enabled smart video system, in accordance with some embodiments.

FIG. 3 illustrates a method performed by the edge-enabled smart video system adopting AI-powered cloud-native NVR devices, in accordance with some embodiments.

FIG. 4 illustrates an example computer system in which any of the embodiments described herein may be implemented.

### DETAILED DESCRIPTION

This invention enhances conventional video surveillance by integrating edge-based video processing, object detection, vectorization, and advanced search functionalities all within a network of intelligent Network Video Recorders (NVRs). The core innovation lies in performing extensive processing at the edge—on the NVR devices themselves—thus enabling real-time, scalable analysis without overwhelming central servers or requiring extensive model retraining. By embedding the results of object detection into textual or numeric vector representations and storing these embeddings in a dedicated vector database (Vector DB), the system supports rich, natural language search queries and customizable alert conditions without necessitating rigidly pre-defined detection models.

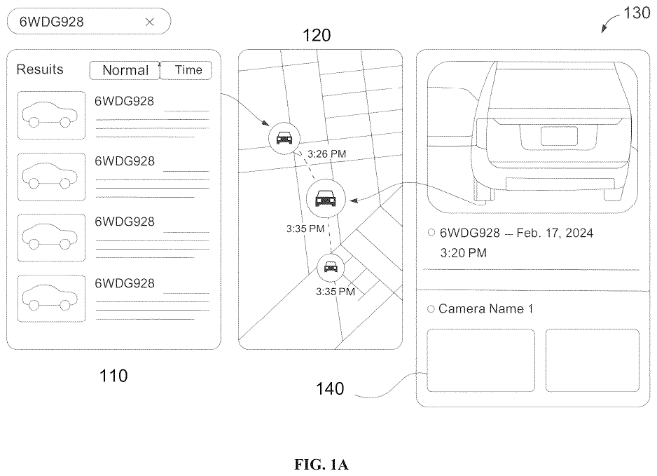

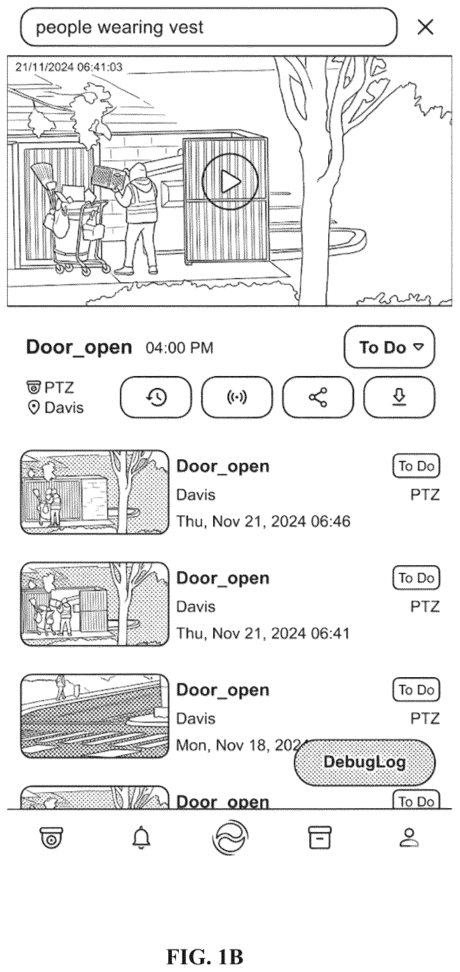

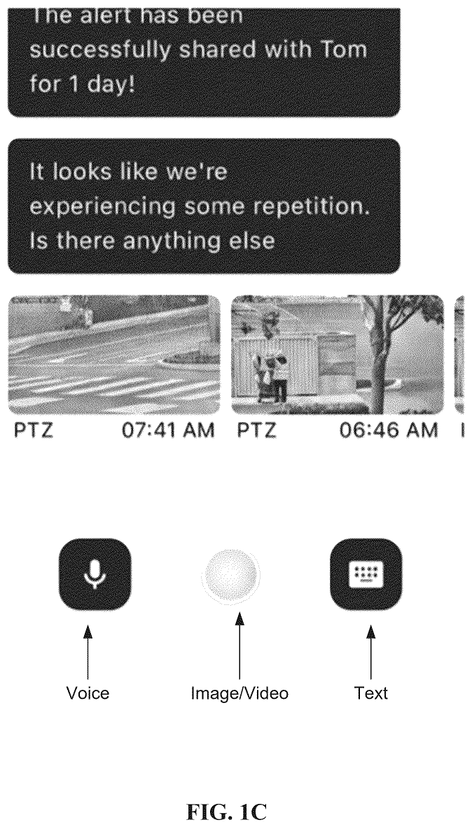

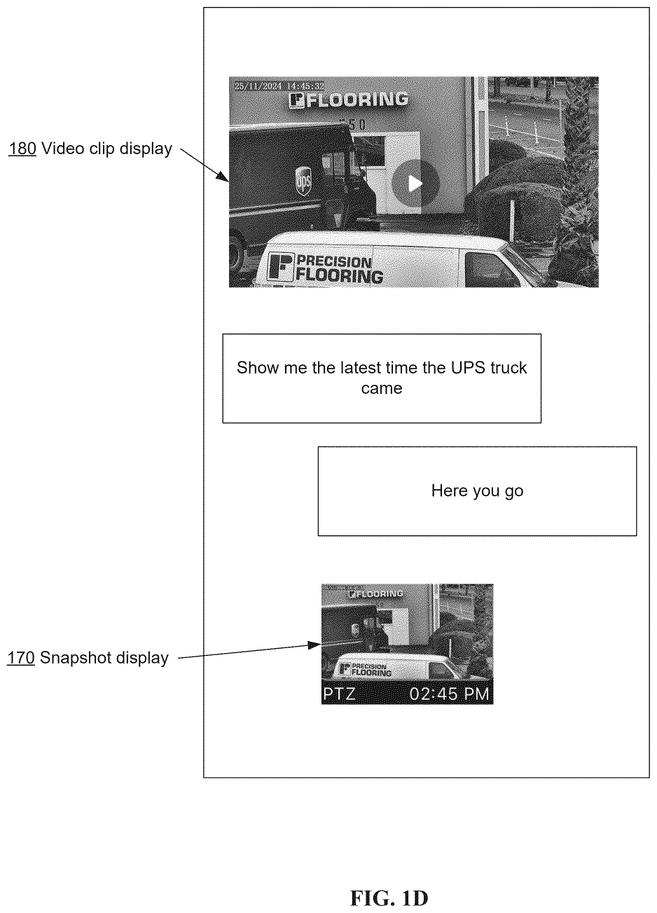

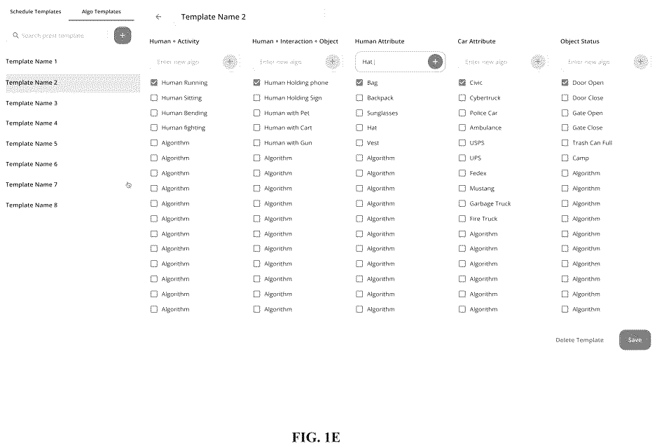

FIGS. 1A-1D illustrate example searches of objects in videos indexed and stored by the edge-enabled smart video system.

Referring to FIG. 1A, an embodiment of the disclosed system and method is illustrated through a graphical user interface that presents the results of a semantic video search. In the underlying system, surveillance video streams are captured via a distributed network of cameras and transmitted to local network video recorders (NVRs). Each NVR comprises at least one processor configured to perform on-device computations, including but not limited to: detecting objects within the received video data; generating textual descriptions corresponding to one or more segments of the video data (for example, at the clip level or frame level); and converting these textual descriptions into corresponding vectorized embeddings that encode semantic attributes associated with the detected objects or events.

These vectorized embeddings, together with their associated temporal indices and metadata (for instance, timestamps and camera identifiers indicating where and when the events occurred), are communicated to and aggregated at a cloud based server. A vector database (Vector DB) on the server stores and indexes the embeddings for similarity based retrieval. This arrangement enables subsequent retrieval of relevant video content based on search queries that may be specified in natural language or in another user friendly format, and the retrieved results are rendered in the user interface shown in FIG. 1A.

In FIG. 1A, a results pane 110 displays a list of video hits that match a license plate query entered by the user (for example, “6WDG928”). When the user issues this license plate query, the system engages a Large Language Model (LLM) to interpret and refine the user's request.

Recognizing that the query matches a license plate format, the LLM generates a context aware prompt, such as “Find a vehicle with the license plate 6WDG928.” This prompt is then converted into one or more vectorized search embeddings. For instance, the search might produce two embeddings: one capturing the concept of a “vehicle license plate” and another capturing the specific identifier “6WDG928.” These embeddings are used to search against the Vector DB, identifying stored embeddings that share high semantic similarity.

This retrieval process may be implemented as a hierarchical or multi stage search. For example, the system may initially retrieve embeddings related to a general category such as “vehicle license plate,” and then restrict the subsequent search to that subset of embeddings to identify those specifically associated with the particular identifier “6WDG928.” By progressively narrowing the search domain, the system efficiently identifies the exact video segments of interest. The user may then be presented with links to or displays of the corresponding video content, with the hits summarized in the results pane 110 and a selected hit shown as a video clip in a video pane 130, aligned with temporal indices of the matched embeddings.

Such methods are not limited to license plate detection and recognition. More generally, the described techniques can be applied to any type of object, event, or attribute detected and described within the video data. The system architecture enables dynamic, context aware searching and retrieval of video content based on a wide range of user defined criteria, without the necessity of predefined rigid taxonomies or exhaustive manual annotation. By performing initial computations at the edge (for example, at the NVR devices) and leveraging advanced embedding based indexing at the cloud server, the disclosed approach provides a scalable, flexible, and efficient framework for retrieving semantically relevant video footage in response to arbitrary user queries.

Since the video clips or frames containing the user searched identifier are associated with timestamps and spatial metadata, the system can present additional contextual data to enhance the user's understanding of the query results. In FIG. 1A, a map pane 120 displays a set of icons corresponding to detections of the queried vehicle at different locations and times. Each icon represents a snapshot of the vehicle taken from a camera at a particular time and place, and the icons may be connected to illustrate a trajectory of the vehicle across captured locations over time based on the spatial metadata associated with the matched video segments.

When the user interacts with the search results, for example by selecting one of the icons on the map pane 120 or selecting a corresponding entry in the results pane 110, the system dynamically updates the video pane 130 to display one or more video clips of the moving object captured by the camera that produced the selected snapshot. At the same time, a camera information region 140 presents camera metadata associated with the selected clip, such as a camera name, location, or model, along with temporal and spatial information derived from the underlying metadata. In this way, the user can see both the video clip in the video pane 130 and the camera specific context in the camera information region 140 for the same detection event.

By providing such features, the system not only retrieves video content semantically matching the user's query but also presents this content in an actionable and interactive format through coordinated use of the results pane 110, map pane 120, video pane 130, and camera information region 140. This enhances the usability and value of the system in scenarios requiring detailed spatial temporal analysis, such as traffic monitoring, security investigations, or logistical oversight.

Referring to FIG. 1B, another example of the disclosed system and method involves a search query for “people wearing vest.” Similar to the process described in FIG. 1A, distributed surveillance cameras capture video streams and transmit them to local NVR devices equipped with AI powered processors. The NVR devices perform on device computations, including detecting objects such as people, analyzing their attributes (for example, clothing), generating text based descriptions of the video content, and creating vectorized embeddings that semantically encode these attributes. FIG. 1B illustrates a graphical user interface in which a search field at the top of the display contains the query “people wearing vest,” a primary video preview region shows a representative clip matching the query, and a list of additional thumbnail clips and corresponding metadata (for example, site, camera, and time) are presented below.

The embeddings, along with associated temporal and spatial metadata, are stored in a cloud based vector database (Vector DB). When the user inputs the search query “people wearing vest,” the system leverages a language model to interpret the query and generate context aware prompts, such as “find individuals wearing a vest.” These prompts are converted into vectorized search embeddings, which are then compared to embeddings stored in the Vector DB.

The search may involve a hierarchical process, first identifying embeddings related to “people” and subsequently refining the results to those specifically associated with the attribute “wearing vest.” The system retrieves the matched video segments and presents them to the user in the interface shown in FIG. 1B, where the user can select any of the thumbnail clips to view the corresponding video in the preview region. In some embodiments, and as described with respect to FIG. 1A, the system may additionally display a map view showing locations where the matches were detected and highlight a corresponding location when a particular clip is selected.

Referring to FIG. 1C, an embodiment of the disclosed system and method provides a multi-modal conversational user interface. In the example shown, prior conversational messages are displayed near the top of the interface, and thumbnail previews of relevant video clips are presented below the messages. At the bottom of the interface, three input controls are provided: a voice input control labeled “Voice,” an image or video input control labeled “Image/Video,” and a text input control labeled “Text.” These controls enable the user to interact with the surveillance video system through different input modes, including spoken commands, textual queries entered via a keyboard style interface, and uploaded reference images or video snippets. By integrating natural language understanding and, optionally, image based search capabilities, the system allows users to specify search conditions in a manner most convenient for them. For instance, a user might verbally request “Show me video clips where a person wearing a blue jacket appears near the south entrance this morning,” type a query such as “Find red cars on Main Street after 5 PM,” or upload an image of a person's face, a particular type of clothing, or a logo to search for visually similar objects in stored video.

Regardless of the modality selected through the Voice, Image/Video, or Text controls, the user inputs are processed by language and vision models that convert the user's request into semantically rich vector embeddings. These embeddings are compared against the Vector DB containing embeddings derived from the video content. This multimodal approach ensures that whether the user provides a spoken query, a text prompt, or a reference image, the system can interpret the request and find relevant matches in the stored video data.

In addition to providing on demand search capabilities, the system offers functionality to define and maintain automated alerts. Using the same conversational interface, the user can specify conditions of interest, for example “person wearing a security vest after midnight,” “a red sedan parked near the loading dock,” or “a known individual appearing in the lobby.” These conditions are similarly translated into vector embeddings. The system can schedule recurring searches, for example through cron jobs or other scheduled tasks, that periodically compare newly generated video embeddings against stored alert embeddings. When a match is found that meets or exceeds a similarity threshold, the system sends a notification to the user, such as an email, SMS message, push notification, or an indication within a dashboard that highlights new matches.

Referring to FIG. 1D, an embodiment of the disclosed system and method enables users to incorporate temporal constraints into their queries through a conversational user interface. As shown, a video clip display 180 presents a clip of a vehicle in a parking lot. Beneath the clip, a user message bubble shows an example natural-language query, “Show me the latest time the UPS truck came,” which integrates both an object of interest (“UPS truck”) and a time-related aspect (“latest time”). A system message bubble (“Here you go”) indicates that the system has processed the request, and a snapshot display 170 presents a thumbnail image and timestamp corresponding to the returned video segment.

To process this request, a front-end AI agent implemented using a large language model (LLM) analyzes the user's text input. The query is interpreted as a search for the most recent occurrence of the specified vehicle within stored video data. The agent converts the query into one or more vector embeddings designed to capture both the semantic meaning of the object (the UPS truck) and the temporal condition (latest occurrence, optionally relative to the current time). These embeddings are submitted to a vector database (Vector DB) containing embeddings extracted from video segments processed at the edge.

The vector database supports time-based filtering in addition to semantic similarity search. By correlating timestamps embedded in the video metadata with embeddings corresponding to “UPS truck,” the system identifies candidate video segments featuring that object and orders them by time. The most recent segment satisfying the query is selected, and the associated clip is surfaced for display in the video clip display 180, while the corresponding thumbnail and timestamp are shown in the snapshot display 170.

Once the result set is retrieved, the system presents it to the user in the conversational format illustrated in FIG. 1D. The interface may display the top matching clip, its timestamp, and additional contextual information such as camera identifier or location. The system can also provide follow-on options (e.g., to share an alert or download the clip) to streamline workflow and decision-making, while preserving the natural, dialog-style interaction enabled by the conversational user interface.

Referring to FIG. 1E, in some embodiments the disclosed system and method provide a user interface (UI) at the level of individual NVR devices, enabling users to tailor the object detection and feature extraction processes performed by the AI module at the network edge. In the illustrated example, a template list panel allows a user to select a particular scenario template (e.g., “Template Name 2”), and a main configuration panel presents multiple semantic categories such as “Human +Activity,” “Human +Interaction +Object,” “Human Attribute,” “Car Attribute,” and “Object Status.” Each category includes a text field (e.g., labeled “Enter new algo”) and an add control, through which the user may create new entries, as well as check boxes that enable or disable specific labels, such as “Human Running,” “Human Holding phone,” “Bag,” “Civic,” and “Door Open.” The UI may be exposed via a local web console, a dedicated mobile or desktop application, or an on-device display, and allows the user to log into a particular NVR and configure object detection parameters, action recognition settings, and semantic attributes to be tracked. Internally, the UI is coupled to a configuration engine that maintains, for each NVR, a set of “scenario profiles.” Each scenario profile may include: (i) a user-readable scenario name; (ii) a natural language description string; (iii) a structured representation of objects, actions, and contextual constraints derived from the description; (iv) one or more scenario embeddings; and (v) runtime parameters such as similarity thresholds, temporal windows, and geographic or camera-specific filters. By writing to this scenario profile store, the system effectively allows the user to define custom AI “algorithms” without directly writing code or retraining models from scratch.

In one example, a user creates a custom definition under a “Human+Activity” category. Suppose the user wishes to receive alerts whenever the system detects a person performing the action of throwing out trash. Through the UI, the user enters a natural language description, such as “human throwing out trash,” and optionally specifies constraints such as a time window (e.g., after 10 p.m.) or a region of interest (e.g., cameras associated with a loading dock). Upon submission, a scenario parsing module running on the NVR or on a lightweight helper service analyzes the description string and maps it into a structured schema, for example:
object type: “person”;
action: “throwing”;
target object: “trash” (mapped to a class such as “bag,” “trash bag,” “garbage can,” or “waste” using a synonym table or language model);
optional context: location tag (e.g., “loading dock”), time-of-day constraint, and minimum duration or number of frames.
The parsing module may consult a local ontology of supported detector labels (e.g., “person,” “vehicle,” “bag,” “bin”) and action recognizers (e.g., “walking,” “running,” “throwing”) to align user-specified terms with concrete model outputs. When a direct match is not found, a language model or embedding-based similarity search can be used to select the closest supported class label.

After the scenario has been mapped to this structured form, the system generates one or more semantic scenario embeddings. In some embodiments, a language embedding model processes the entire natural language description to produce a “global” scenario embedding, and also processes individual components (e.g., “human,” “throwing,” “trash,” “at loading dock after 10 p.m.”) to produce “component” embeddings. The resulting vectors, together with the structured schema and thresholds, are stored in the scenario profile for that NVR. At runtime, as the NVR processes incoming video, its AI module performs object detection and, optionally, action recognition and caption generation. For each clip or frame window, the module (i) records low-level detections, including object type, bounding box, action label, and confidence scores, and (ii) generates a text-based description, such as “a human throwing out a bag into a bin next to the loading dock.” This text is passed through the same embedding model to obtain one or more clip embeddings (for example, a clip-level embedding plus per-phrase embeddings corresponding to “human,” “throwing,” “bag,” and “bin”). The NVR may maintain these clip embeddings in an in-memory buffer keyed by timestamps and camera identifiers, and may optionally build a lightweight local vector index (e.g., a small approximate nearest neighbor index) to accelerate scenario matching on the device.

To evaluate whether a given clip satisfies a user-defined scenario, a scenario matching module on the NVR computes one or more similarity scores between the scenario embeddings and the clip embeddings. In some implementations, a cosine similarity or dot-product metric is used to compare the global scenario embedding against each clip-level embedding, while additional comparisons are performed between component embeddings and corresponding object- or phrase-level embeddings. The module may then aggregate these scores according to a rule specified in the scenario profile, such as requiring that (i) the similarity between the global scenario embedding and the clip-level embedding exceed a first threshold, and (ii) the similarities for the “person,” “throwing,” and “trash-related object” components each exceed component-specific thresholds, and (iii) the clip metadata satisfies the contextual constraints (e.g., time-of-day and camera location). When these conditions are met, the clip is marked as matching the scenario. Because the embeddings for a clip such as “a human throwing out a bag into a bin” are very close in embedding space to the embeddings associated with the user's requested scenario “human throwing out trash,” the matching module will classify this clip as satisfying the defined alert condition.

In practical use, when a clip is identified as satisfying a scenario, the NVR may immediately append a record to a local alert log, raise a real-time event over a message bus, and optionally transmit a compact alert payload (for example, the clip identifier, timestamp, camera ID, and a short preview) to a cloud management service or client application.

In some embodiments, the scenario profiles themselves are stored and executed entirely at the NVR and evaluated by a local scenario matching module that operates on embeddings and detector outputs produced by the NVR's existing AI models. In other words, a scenario definition (e.g., a user defining a new scenario for triggering alarms) does not introduce a new detector class into the underlying object detection or action recognition networks. Instead, the scenario is represented as a combination of semantic embeddings and constraints that are evaluated against outputs of fixed, pre-deployed models (that classify objects and motions from a series of images or video clips). Because the matching module only consumes existing detection results and clip embeddings, the NVR can support user-defined new scenarios by updating scenario profiles rather than modifying the AI models themselves (i.e., no need to retrain the model or deploy a new model).

In conventional systems, enabling detection of a new concept such as “human throwing out trash” typically requires changing the behavior of one or more trained models. For example, a vendor may need to train a specialized classifier (or updating an existing classifier) for that concept or update the label space and parameters of an existing object detection or action recognition model so that the model emits a new output class corresponding to the concept. After training, the updated model binary must be packaged and pushed to hundreds or thousands of field-deployed recorders. These approaches are expensive and disruptive: they require curating labeled training data, consuming significant compute resources for training, transmitting large model files over constrained wide area networks, and scheduling maintenance windows or reboots on devices with limited memory and storage. Moreover, every new concept potentially increases the model's output dimensionality and memory footprint on the NVR, and may introduce accuracy regressions that require further validation and tuning.

By contrast, the disclosed system is designed so that new user-defined behaviors are expressed entirely at the level of configuration and embedding-based matching, rather than at the level of model parameters. This way, the system avoids retraining or redeploying the underlying object detection and action recognition models (collectively called “base models”) when a user wishes to monitor a new type of behavior or object/action detection pattern.

In some embodiments, the “base models” executed on the NVR include one or more of the following: (i) a lightweight object detection model composed of a convolutional or transformer-based backbone coupled with a detection head; (ii) an action recognition model, such as a temporal shift module (TSM) network, a 2+1D convolutional model, or a lightweight video transformer, which produces both action labels and temporal action embeddings; and (iii) a captioning or clip-description model employing a compact vision encoder and a small language decoder, such as an LSTM or a tiny Transformer decoder, that generates natural-language descriptions of detected events. The produced descriptions may be further processed by an embedding model, for example a sentence encoder, to generate clip-level semantic embeddings. These models, in addition to any discrete class labels, generate fixed-length numeric embeddings, for example 128 to 1024 dimensions, that occupy a shared semantic vector space.

The embeddings serve as a modular, model-agnostic interface: any vision or language model that maps video content or text into the same embedding space can be swapped or upgraded without changing the format of the data consumed by the scenario matching logic. Scenario evaluation and alerting are implemented downstream of this embedding layer and do not require modifying model weights, reinitializing network parameters, or expanding classifier output layers when new behaviors are introduced.

More specifically, the object detection and captioning components may each include a deep neural network backbone, such as a convolutional network or transformer encoder, that produces high-dimensional feature maps from input video frames, followed by one or more learned projection heads that apply linear transformations, normalization, and pooling operations to convert those feature maps into fixed-length numeric vectors. For object-level detection, each detected instance such as a person, a bag, or a vehicle is associated with an object embedding computed from features within a region of interest. For clip-level description, the captioning module generates a text string and a language embedding model converts that string into a clip embedding. All such embeddings may be represented as floating-point or quantized integer arrays, for example 256- or 1024-dimensional vectors stored in device memory, and lie in a shared high-dimensional vector space in which semantically related concepts are mapped to nearby coordinates.

A user-defined scenario is processed through the same language embedding model, yielding one or more scenario embeddings in that same vector space. Matching a new scenario therefore reduces to applying purely numerical similarity operations, such as computing cosine similarity, dot products, or L2 distances between scenario embeddings and clip or object embeddings, implemented as vectorized matrix multiplications on the NVR's CPU, GPU, or AI accelerator, optionally combined with thresholding and logical constraints on existing detector outputs, for example requiring embeddings corresponding to “person”, “throwing”, and a “bag-type object” to co-occur within a temporal window.

Because the scenario engine operates entirely on these fixed-dimension embedding vectors and existing detector outputs, no gradients are computed, no network layers are modified, and no additional output heads are added when a new scenario is defined. Instead, only a lightweight scenario profile is added or modified, containing the natural language description, the structured schema of objects and actions, associated scenario embeddings, similarity thresholds, and contextual filters. This profile can be installed as a small configuration update, for example by updating a configuration file or a record in a local key-value store, and is applied at runtime using the NVR's existing inference pipeline without pausing video ingestion or inference, without downloading a new model, and without increasing the model's memory footprint. In this way, the modular embedding outputs provide a concrete technical improvement: they allow the system to change high-level detection behavior in response to user-defined scenarios while keeping the underlying models fixed, thereby improving manageability and preserving stable, real-time operation across large, distributed camera deployments.

To further illustrate the technical advantage of the disclosed modular embedding architecture, consider a user who wishes to define a new behavior, “human stacking boxes,” even though this concept was not part of the training set of the NVR's base models. In conventional systems, enabling detection of such a new behavior generally requires modifying the underlying action recognition network, adding an additional output class corresponding to the new concept, retraining the network with labeled video data showing instances of the new behavior, and redeploying an updated model binary to each field device. The disclosed system avoids all such retraining and redeployment steps because the NVR evaluates user-defined behaviors entirely through embedding-based similarity computations rather than by expanding the label space of any detection or action model.

When the user enters “human stacking boxes” into the NVR interface, the language embedding model running on the NVR converts this textual description into a fixed-length numeric scenario embedding. For example, the text encoder may map the phrase into a 768-dimensional embedding vector stored in a scenario profile. The scenario profile contains the scenario embedding, one or more constraint conditions such as requiring detections of “person” and “box,” and a similarity threshold that indicates the minimum required semantic match. No neural network weights are modified, and no new classification neurons or output heads are added to the base object or action recognition models. The only new data introduced into the system is the scenario profile, which is typically a small configuration record occupying only a few kilobytes. As the NVR continues processing live video, the base object detection model emits object embeddings for each detected object instance, such as a person or a box, and the captioning model generates a natural-language description of each clip. The description is processed by the text embedding model to produce a clip embedding, for example a 768-dimensional vector representing the caption “a person placing a box on top of another box.” Because the embedding model maps semantically related phrases to nearby points in the vector space, a clip describing “placing one box on top of another box” often lies near the user-defined scenario embedding for “human stacking boxes,” even if the exact phrase “stacking boxes” never appeared in the training data of the captioning or detection models.

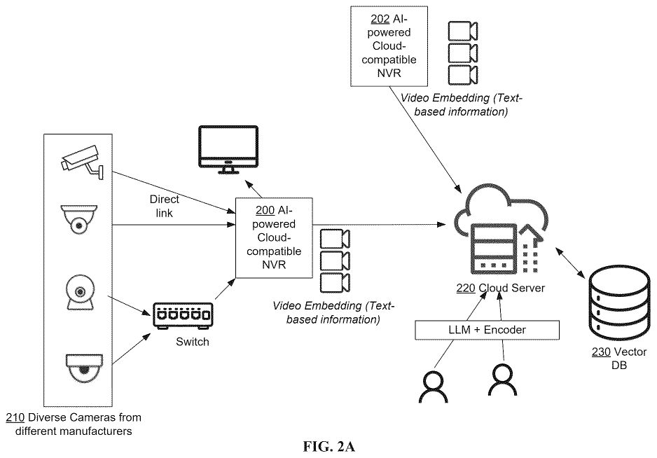

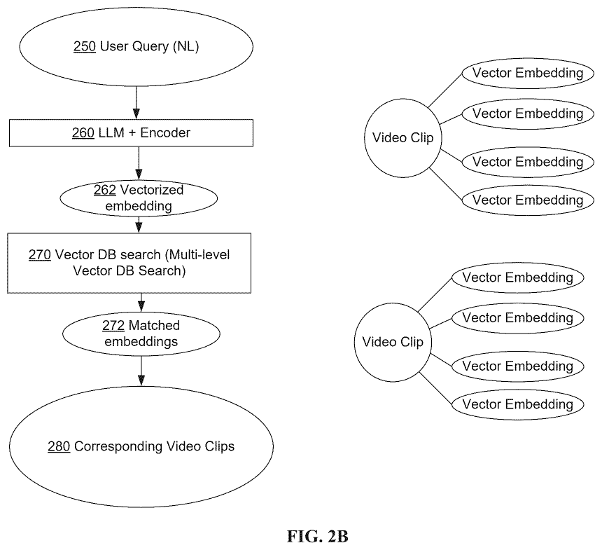

FIG. 2A illustrates an embodiment of an edge-enabled smart video system that employs AI-powered, cloud-native NVR devices for large-scale, real-time video surveillance analytics. In this configuration, a plurality of local stations each includes one or more AI-enabled NVRs (for example, NVR 200 and NVR 202) connected to a variety of IP cameras 210, potentially sourced from different manufacturers, via a network switch or direct Ethernet links. Each camera streams compressed video (for example, H.264 or H.265 over RTSP or other IP protocols) to the NVR.

In some embodiments, the NVR includes a network ingestion module that receives and terminates the incoming video streams at the NVR, decodes the compressed frames into raw image buffers, and stores the decoded frames in per-camera ring buffers located in the NVR's main memory. Each ring buffer provides a bounded, lock-free, producer-consumer structure that decouples the real-time arrival of video frames from the downstream AI inference pipeline. This design prevents memory growth when inference temporarily lags behind ingestion, isolates high-activity cameras from affecting other streams, and enables concurrent decoding, batching, and inference to proceed without blocking. These machine-level mechanisms allow the NVR to sustain real-time operation across large numbers of cameras using limited on-device computational and memory resources.

As shown in FIG. 2A, by distributing video decoding and initial analysis across the NVRs at the edge (here, the “edge” refers to the NVR-level edge, not the IP camera-level edge), the system supports real-time analytics at high frame rates, typically around 25 frames per second, and can manage feeds from thousands of cameras simultaneously by assigning each NVR a disjoint subset of the camera streams.

In some embodiments, the NVR devices incorporate lightweight AI models optimized for on-device execution, as described above. As video frames arrive in the ring buffers, a frame scheduler running on each NVR selects frames or short sequences according to a policy, such as processing every frame, every Nth frame, or adapting the sampling rate based on motion level.

These selected frames are batched and passed to the object detection and attribute extraction models. The models perform object detection, attribute inference, and visual analysis, generating object-level outputs such as class label, bounding box coordinates, appearance features, and optional motion vectors for each detected instance. Attributes such as object class, inferred color, approximate size, on-screen position, and estimated trajectory are thus identified as the video is captured. A learned embedding model, for example a projection head on top of the detection backbone, maps these attributes and features into dense vector embeddings that semantically represent the detected entities and events. These embeddings encode complex visual and conceptual information into structured, high-dimensional numeric representations. By mapping semantically related attributes close together in embedding space, the system enables rapid similarity-based retrieval and downstream scenario matching.

To provide more context-rich results, the NVR devices can also generate text-based descriptions of video segments, potentially at the clip or frame level, and process them with language models. In some embodiments, a captioning module aggregates object detections and motion cues over a configurable time window, for example one to five seconds, and produces a natural-language description such as “a person in a yellow vest walks past a parked truck.” A language model refines these textual narratives into semantically meaningful descriptions and may segment them into independent conceptual units, for example separating “a person in a yellow vest” and “a parked truck.” Each textual unit is then vectorized by a sentence or phrase embedding model, producing embeddings that correspond not only to visual attributes but also to the broader semantic content described in natural language. These clip-level and phrase-level embeddings share the same vector space as the object-level embeddings, allowing unified similarity search.

These video embeddings, including both object-level embeddings and text-derived clip or phrase embeddings, are periodically aggregated and transmitted from the NVRs to a Vector DB hosted on a cloud server 220 or a data center cluster. An embedding export module on each NVR groups embeddings into time-bounded batches, attaches metadata such as timestamps, camera identifiers, and station identifiers, and sends the batches over a secure, bandwidth-aware channel. Unlike conventional relational databases, the Vector DB stores embeddings as high-dimensional vectors and uses specialized indexing structures and algorithms, such as approximate nearest neighbor (ANN) searches, for vector similarity comparisons. In some embodiments, embeddings are first normalized and optionally compressed into product quantization codes or other compact representations before being inserted into the index. These optimizations allow the Vector DB to handle millions or billions of embeddings while keeping lookup operations rapid and computationally manageable as the system scales to enormous volumes of video data.

On the query side, users may interact with the system by issuing queries in natural language, providing voice commands, or supplying reference images. A front-end query service receives the user input and passes text or transcribed speech through a language model that refines and interprets the user's request, resolving ambiguities and extracting relevant entities and conditions. The interpreted query is then converted into one or more query vectors in the same semantic vector space used by the NVR embeddings. If a reference image is supplied, a vision encoder generates one or more image embeddings that are likewise projected into this space. Since the textual embeddings, clip embeddings, and object embeddings share the underlying semantic space, the query vectors can be directly compared to stored embeddings in the Vector DB. A query planner component selects appropriate indexes and search parameters, and the Vector DB swiftly identifies close matches, retrieving references to relevant video segments and frames.

In addition to ad hoc searches, users can define alerts by describing events or conditions in natural language, such as “Alert me if someone carrying a large package enters the restricted area after midnight.” This description is converted into one or more alert embeddings and associated constraints and stored as an alert profile. In some embodiments, the alert profile is evaluated both at the edge and in the cloud. At the edge, each NVR maintains a rolling window of recent embeddings in local memory or local storage and continuously compares newly generated embeddings from its live video streams against the alert embeddings. This supports real-time response with minimal latency, because matching is performed directly on the device that is already running inference. In parallel, the NVR may periodically upload batches of embeddings and their metadata to the cloud-hosted Vector DB, which maintains a longer-term historical store that may span hours, days, or longer than the local window. The cloud alert service periodically executes similarity searches over newly arrived and previously stored embeddings, for example using scheduled jobs or continuous streaming queries, so that alerts can also be raised based on historical embeddings that are no longer retained on the NVR (this may cover cases in which a newly defined user alert triggers both the NVR to screen freshly captured video streams and the cloud service to scan the historical embeddings). In some deployments, certain NVR models or configurations may have limited on-device matching capabilities and are configured to primarily or exclusively upload embeddings to the cloud, relying on the cloud alert service to evaluate alert profiles on their behalf. This division of responsibilities allows resource-constrained NVRs to offload heavy alert evaluation while still benefiting from real-time or near real-time alerting through the shared cloud infrastructure. This architecture allows the system to offer both low-latency local alerts and deep historical recall without changing the base models, just by changing where and how the embedding comparisons run.

In some embodiments, alert definition and management are provided by a centralized alert management service executing on the same cloud infrastructure that hosts the Vector DB or on another server that coordinates a fleet of NVRs. A user defines an alert condition once through a management user interface that communicates with the centralized alert management service. The service processes the alert description with the same or a compatible language model used on the query side to generate alert embeddings and associated constraints, stores the resulting alert profile in a global alert registry, and distributes the alert profile to multiple NVRs that are registered with the service. Each participating NVR subscribes to one or more alert profiles and performs local matching against its live video streams as described above, while the centralized alert management service also applies the alert profile to embeddings stored in the cloud-hosted Vector DB so that a single user-defined alert can be evaluated across video data originating from multiple NVRs and sites.

By integrating edge-based AI computations, dense semantic embeddings, and a scalable Vector DB for similarity-based queries, the system illustrated in FIG. 2A delivers a combined improvement in responsiveness and throughput. Heavy inference workloads, such as object detection and caption generation, are executed on the NVRs close to the cameras, reducing the volume of raw video that must traverse the network. Only compact embeddings and selected clips are transmitted upstream. At the same time, the cloud-hosted Vector DB and query services provide a central point for cross-site search, alert management, and long-term analytics. This division of labor allows the system to provide intuitive and efficient video search and alerting functionalities while keeping per-device resource usage bounded and preserving low-latency, real-time behavior.

One of the key technical hurdles addressed by this invention is the need for real-time analytics across thousands of camera streams, each delivering video at approximately 25 frames per second. As mentioned above, on each NVR, the ingestion, decoding, inference, embedding generation, and export tasks are organized into concurrent stages connected by lock-free queues or ring buffers. Frames are processed in batches sized to match the throughput characteristics of the AI accelerator, and backpressure mechanisms dynamically adjust sampling rates or queue lengths if any stage becomes saturated. This pipelined design ensures that even under heavy load, the end-to-end latency between frame capture and embedding generation remains within a bounded, predictable range.

On the hardware side, in some embodiments, each smart NVR integrates specialized AI inference accelerators, such as GPUs, TPUs, or custom AI chips, engineered for rapid image and video processing. These accelerators utilize parallel pipelines, SIMD instructions, and high throughput memory architectures to achieve low latency execution of object detection and embedding models. Video frames and intermediate feature maps may be stored in contiguous memory buffers aligned to cache line boundaries to minimize cache misses. Additional optimizations, including on chip weight compression, fused convolution and activation kernels, and dedicated vector arithmetic units for matrix multiplication, further reduce inference time.

Within a single NVR, a local scheduler process executing on a general purpose processor monitors per stream metrics such as frame processing latency, input queue depth, accelerator core utilization, and detected object density (for example, the average number of detected objects per frame over a sliding time window). The scheduler assigns each camera stream to a processing pipeline bound to a particular subset of accelerator cores and dynamically reassigns streams when any monitored metric crosses a threshold, for instance migrating a camera feed with dense activity to a less loaded core group while reassigning a sparse feed to the previously busy cores. In this way, the NVR partitions workloads among multiple processors or accelerator cores within the same device, for example assigning different camera groups to different cores, to balance computational tasks and maintain a stable 25 fps throughput for each active stream.

In some embodiments, a cluster-level load balancing service (e.g., on a centralized server or a cloud service managing the fleet of NVR) operates in conjunction with the local schedulers to distribute camera streams across multiple NVRs at a site. For instance, each NVR executes a lightweight agent that periodically reports telemetry to the load balancing service, such as aggregate frame processing latency, average accelerator utilization, memory usage, number of active streams, and scene complexity indicators derived from detection statistics, including per stream and per device counts of detected objects per second or per frame. The load balancing service computes a load score for each NVR based on these metrics and, when a new camera is added or when an existing NVR becomes overloaded, selects a target NVR according to a policy such as lowest load score or latency aware weighted round robin. The service then updates camera configuration to redirect the network video stream to the selected NVR, for example by modifying RTSP endpoints, updating a stream routing table, or instructing a switch or gateway device to forward the stream to a different NVR IP address. By incorporating scene complexity determined from detected object density in addition to raw hardware utilization, the cluster level load balancing service can preferentially move camera streams with highly crowded or event rich scenes away from saturated NVRs, thereby maintaining consistent end to end performance even as activity levels and camera counts fluctuate.

On the software side, in some embodiments, the system employs a suite of model compression and optimization methods to streamline deep learning workloads at the edge. Techniques like pruning remove redundant weights and inactive channels, reducing model size and computational load while preserving accuracy within predetermined bounds. Quantization converts floating-point operations into lower-precision integer calculations, such as INT8, substantially cutting computation and memory bandwidth requirements while maintaining adequate model fidelity. Compiler-level optimizations, such as kernel fusion, operator reordering, and hardware-specific code generation, further shrink inference times by reducing memory round trips and exploiting accelerator-specific instruction sets. The NVR's inference runtime can also adapt batch sizes and thread pool configurations based on measured latency and utilization metrics, enabling more objects to be analyzed per second without overwhelming system resources.

Once object embeddings and clip embeddings are generated at high volume, efficiently storing, indexing, and querying them in a Vector DB poses another significant challenge. To handle potentially billions of vector embeddings, the system relies on indexing strategies tailored for approximate nearest neighbor searches. In some embodiments, incoming embeddings are first assigned to coarse clusters using a k-means or inverted file index, and then finer-grained search is performed within each cluster using structures such as kd-trees, hierarchical navigable small-world (HNSW) graphs, or product quantization codebooks. Frameworks such as FAISS, ScaNN, or Annoy may be used to implement these structures. This multi-stage indexing reduces query complexity to near-constant or logarithmic time in practice, ensuring rapid similarity searches even as data scales.

To maintain consistent performance as the number of cameras and stored embeddings grows, the Vector DB is designed for horizontal scalability through sharding and replication. Each shard maintains its own ANN index over a disjoint subset of embeddings and can be hosted on a separate physical or virtual node in a distributed cluster. In some embodiments, a dedicated query router service executes as a stateless microservice within the same cluster and is responsible for determining which shards must be consulted for a given query. The query router may select shards based on one or more metadata keys, such as site identifier, time range, camera group, or object category, and dispatch parallel search requests to the selected shards using a remote procedure call or HTTP based application programming interface.

In addition, a load balancer component, which may be implemented as a standalone microservice or integrated with a service discovery layer, distributes incoming query and insertion traffic across equivalent shard replicas to avoid hotspots. Each shard node periodically publishes telemetry to the load balancer, including metrics such as current query latency, request throughput, CPU and accelerator utilization, memory pressure, and queue depth. The load balancer uses these metrics to select a target replica according to a configurable policy, for example least loaded, latency aware round robin, or weighted random selection. Replication across shard replicas provides fault tolerance and high availability, while in memory caches of frequently accessed embeddings and precomputed search results maintained at the shard nodes or at the query router further accelerate retrieval times for common queries and alerts. In the event that a shard replica becomes unhealthy or unreachable, health checks performed by the service discovery layer cause the load balancer to temporarily remove that replica from rotation and redirect traffic to remaining replicas without interrupting service.

The software architecture also embraces concurrency, asynchronous processing, and modular microservices. Individual services may be dedicated to tasks such as receiving camera streams, performing inference, exporting embeddings, ingesting embeddings into the Vector DB, executing queries, and managing alert profiles. These services communicate using asynchronous message queues or lightweight RPC calls, allowing them to scale independently. Batching incoming frames, embedding insertion operations, and query requests improves throughput by amortizing overhead across multiple items. By decoupling object detection, embedding computation, and database insertion into independent services, each component can be scaled out or upgraded without affecting the others. Elastic scaling, for example adding more NVRs, additional AI accelerators, or extra Vector DB nodes, enables the system to adapt to changing demand, and containerization supports rolling updates and continuous deployment of new models, embedding configurations, or indexing strategies without service interruption.

Referring to FIG. 2B, an embodiment of the disclosed system and method details a multi-stage, iterative search process that leverages vector embedding techniques for optimized retrieval. Again, the search here may include ad hoc searches or alert-based searches. When a user issues (or an alert triggers) a natural language query, such as “a small red car parked near the loading dock after midnight”, the system employs a large language model to interpret the user's request. The language model performs semantic parsing to identify distinct components of the query, for example object type (“car”), attributes (“small”, “red”), location (“near the loading dock”), and temporal constraints (“after midnight”). The language model then converts these components into a set of semantic vector embeddings 262, where each embedding corresponds to one semantic element or a small group of related elements. In some embodiments, the model also outputs weights or confidence scores that indicate the relative importance of each component, which are used later when ranking results.

The embedding step 260 thus transforms the high-level, human-understandable request into a structured, machine-readable representation. For instance, the phrase “small red car” may yield separate embeddings representing “car”, “red”, and “small”, as well as a composite embedding representing the conjunction of those attributes. Temporal and situational conditions, such as “parked near the loading dock after midnight”, may be represented by additional embeddings encoding the concepts of “parked”, “loading dock”, and “after midnight”, together with explicit time range and location filters derived from the parsed query. The resulting query representation consists of a set of embeddings, each tagged with its semantic role and associated filter conditions.

Once the query embeddings are generated, they are passed to a Vector DB 270 along with any accompanying metadata filters, such as camera identifiers, site identifiers, or time windows. Unlike traditional keyword-based searches that operate on inverted text indexes, the Vector DB performs similarity searches in a high-dimensional semantic vector space. Each video clip or frame stored in the database is associated with one or more vector embeddings that describe different aspects of the content, including but not limited to object type, shape, color, size, material, action, location, and time-related attributes. These embeddings may originate from object-level features, clip-level captions, or other modalities as described earlier. By encoding diverse feature sets into a shared embedding space, the system produces a rich semantic representation of each video segment, which supports granular and context-sensitive retrieval.

The Vector DB 270 constructs and executes a multi-level, iterative search plan based on the parsed query. In one embodiment, the search query is decomposed into multiple rounds of vector-based filtering, where each round operates on a subset of the query embeddings and further constrains the candidate set of video segments. For example, a first round may use the “car” embedding to identify all clips whose object or caption embeddings are semantically close to the concept of a car, subject to coarse metadata filters such as a site or time range. A second round then narrows this candidate set by applying an embedding corresponding to “red”, filtering out clips that are not semantically consistent with a red object. A third round applies the “small” attribute embedding, further pruning the search space. Additional rounds can apply spatial and temporal embeddings related to “near the loading dock” and “after midnight”, which are combined with explicit time range and camera location filters. At each stage, only the identifiers and scores of the surviving candidates are carried forward, so later rounds operate on significantly fewer items.

By employing this iterative process, the Vector DB effectively reduces a massive initial search space to a highly relevant, context-specific subset. Each subsequent search round is restricted to the narrowed-down result set from the previous round, which reduces the number of vector similarity computations and memory accesses required at each step. In some embodiments, different query components may be treated as required, optional, or boost-only conditions, so that the search plan can model soft conjunctions and trade off strictness versus recall. The final result set consists of those video segments whose embeddings jointly satisfy the semantic and metadata constraints implied by all relevant query components. This staged filtering allows the system to efficiently pinpoint the exact video segments of interest without scanning the entire database or relying on a single monolithic similarity operation.

Once the final set of matched vector embeddings is identified, the system maps these embeddings back to their corresponding video clips or frames 280 using stored identifiers, timestamps, and camera metadata. The user is then presented with the relevant video results in a suitable format, such as thumbnail previews, direct links to the matched timestamps, or annotated clips that highlight the detected objects and attributes that contributed to the match. In some embodiments, the system also returns per-attribute scores that indicate how strongly each result matches the different components of the original query, enabling the user to understand why particular clips were retrieved and to refine the query if needed.

This multi-level search schema yields improved search performance and accuracy compared to naive approaches that either rely on keyword matching or attempt to match a single, undifferentiated query embedding against all stored embeddings. By breaking down complex, multi-attribute queries into iterative semantic filters and applying explicit metadata constraints at each stage, the system provides a targeted retrieval mechanism that can honor intricate and nuanced criteria. The comprehensive embedding approach, in which each video clip is associated with multiple embeddings representing different feature aspects and time intervals, ensures that the user can specify rich combinations of objects, attributes, locations, and temporal conditions while still obtaining precise, meaningful results.

A key advantage of the disclosed system lies in its ability to provide real-time search capabilities and low-latency query responses. Unlike conventional architectures that rely on performing object detection and model inference at query time, the proposed system pre-computes semantic embeddings at the edge on the NVR devices. As each video stream is captured, the NVRs extract object attributes, generate textual descriptions, and transform those descriptions into vectorized embeddings. These embeddings encode a comprehensive range of features for every frame or clip, such as object type, size, color, location, and temporal context, and are stored in a structured, high-dimensional vector space within the Vector DB. By the time a user submits a search query, the relevant embeddings have already been computed and indexed, eliminating the need for expensive on-demand inference during the search.

This proactive, edge-based approach dramatically reduces latency. Instead of executing deep neural network inference whenever a user issues a search request, the system only needs to perform vector similarity lookups and combination logic over the pre-computed embeddings. Since these embeddings are already present in the Vector DB and organized using approximate nearest neighbor indexing techniques, such as inverted file indexes with product quantization or graph-based indexes, queries can be resolved in milliseconds even when searching through millions or billions of embeddings. Users can therefore receive near-instantaneous search results, interactively refine their criteria, or rapidly switch between different query formulations without incurring the delays associated with systems that must run full inference at query time.

The combination of edge-distributed computation and scalable vector indexing also enables the system to serve multiple users simultaneously with minimal performance degradation. Traditional methods that perform object detection and captioning in real time for every query or user request become prohibitively slow and costly as the number of users and cameras increases, because inference must be repeated for overlapping portions of the video. In the disclosed system, each NVR performs object detection and feature extraction locally and continuously, so that heavy neural network workloads are amortized across all future queries. The Vector DB then performs lightweight similarity and filtering operations over the shared embedding space. As a result, surges in user demand or expansions in camera coverage can be handled by adding NVRs or Vector DB nodes and adjusting load distribution, while maintaining real-time responsiveness.

Moreover, because all relevant semantic details are captured and embedded before queries arrive, the system supports real-time, customized alerts as described above. Instead of waiting for a model to run in real time only when an event is suspected, the system continuously compares newly generated embeddings against user-defined alert embeddings. If a match exceeding a similarity threshold is found and associated constraints are satisfied, the system triggers an alert immediately. The same multi-stage matching and vector indexing infrastructure used for search is reused for alert evaluation, which allows both interactive queries and continuous monitoring to benefit from the same optimized embedding pipeline. This proactive approach enables security personnel, traffic managers, or other users to respond instantly to evolving situations, greatly enhancing situational awareness and operational efficiency.

In essence, by pre-computing semantic embeddings at the edge, decomposing user queries into structured sets of embeddings and constraints, and employing multi-stage vector indexing structures in the cloud, this invention delivers a concrete technical improvement in both latency and scalability. It combines the flexibility of distributed, edge-based processing with the power of semantic embedding and iterative vector similarity searches. The result is a system that reliably produces real-time, low-latency search results and instant alerts across large, heterogeneous video deployments, outperforming conventional methods that depend on costly, on-demand inference or simple keyword search and making rich, “magic search” style interaction with video archives practical and robust.

### Detailed Description of the AI-Powered NVR

An NVR is a pivotal element in contemporary surveillance systems, designed to interface seamlessly with IP (Internet Protocol) cameras. Unlike DVRs (Digital Video Recorders), which are tailored for analog cameras, NVRs capture and preserve video content from networked cameras over an IP network.

NVRs are crucial in settings that demand robust, high-fidelity surveillance, such as commercial sites, industrial complexes, educational institutions, and residential areas where security is crucial. They offer a scalable and reliable solution capable of delivering high-resolution video feeds, essential for effective monitoring of expansive spaces. The implementation of Power over Ethernet (POE) streamlines camera installation by facilitating power delivery directly through network cabling, thus allowing cameras to operate independently of direct power source availability.

This disclosure focuses on NVR devices for scenarios requiring expansive coverage and the management of numerous cameras, ensuring high-quality surveillance without degradation of video fidelity. These systems are equipped to manage a substantial amount of high-resolution video data, offering extensive storage capabilities. They support a multitude of cameras, including those from various manufacturers, as long as they comply with standard IP protocols. Contrastingly, WiFi camera systems are typically preferred for their user-friendly setup, catering to home and small business users who may prioritize convenience and ease of use over the expansive, integrated capabilities of NVR systems.

A person having ordinary skill in the art would recognize that WiFi camera systems and NVR systems are engineered to address distinct technical challenges and operational environments. Given their divergent design principles, functionalities, and intended applications of these different types of systems, it would not be obvious to one skilled in the art to apply teachings or solutions from WiFi camera systems directly to NVR systems without inventive effort.

The following description describes an AI-powered, cloud-native NVR device designed to overcome the limitations of traditional video surveillance systems. Conventional approaches often constrain users by restricting them to specific camera manufacturers, limiting their ability to run advanced analytics at the recording device level, and confining video storage and retrieval to local infrastructures. By contrast, this NVR device is manufacturer-agnostic, integrates AI processing capabilities at the edge, and supports direct cloud storage access. Together, these features simplify deployment, expand functionality, and promote seamless remote access and collaboration.

The compatibility with a wide range of IP cameras is a crucial aspect. Instead of requiring costly replacements, the NVR device works with virtually any existing IP camera infrastructure. Users can preserve their current hardware investments, avoiding expensive and disruptive upgrades. This open integration model makes advanced surveillance technology accessible and cost-effective, regardless of the diversity of communication protocols, compression formats, resolutions, frame rates, or security features used by different camera models.

Another key enhancement is the incorporation of AI-based video analytics directly within the NVR. Traditionally, processing video data for object detection, event recognition, or motion analysis required centralized servers or post-processing steps. By performing these tasks at the edge, right on the NVR, the system provides real-time insights and can intelligently filter footage before it is sent to the cloud. The result is more efficient bandwidth usage, faster response times, and a reduction in the clutter of unnecessary footage. Users can define criteria for what constitutes relevant video, ensuring that only the most pertinent clips are stored, reviewed, or analyzed further.

Direct access to cloud storage revolutionizes how video surveillance data is managed and accessed. Instead of confining video archives to on-site hardware, users can securely store and retrieve footage from anywhere with internet access. This eliminates the limitations of local storage capacity and enhances disaster recovery resilience, as critical footage remains protected even if local hardware fails. Additionally, centralized cloud storage simplifies sharing and collaboration, allowing multiple users or sites to view and analyze video content without complex networking arrangements.

Underpinning these capabilities is a firmware architecture that unifies camera integration, AI-driven analytics, and cloud connectivity. The camera-integration module ensures compatibility and unified management of diverse IP cameras. The AI module analyzes live video streams, extracting meaningful information while operating within the device's resource constraints. The cloud-access module manages intelligent data transfers, sending selected and prioritized footage to remote storage. A firmware update interface supports ongoing improvements, enabling the system to evolve by incorporating new camera protocols, deploying updated AI models, or adjusting cloud parameters over time.

To simplify operation, a user interface allows for intuitive system configuration. Users can set up cloud credentials, define important video attributes, and create automated workflows triggered by events detected in the footage. For instance, the system might automatically record and flag a video segment when it recognizes a particular individual, send an alert when a vehicle enters a restricted zone, or grant access by controlling barriers when a known person approaches. These intelligent workflows greatly enhance the system's value, enabling an integrated surveillance solution that goes beyond passive recording and towards active and responsive security management.

The NVR employs a pool of communication protocols, each associated with a particular camera provider's standards. When an IP camera from a specific manufacturer is connected, the NVR automatically activates the appropriate protocol, ensuring seamless communication and reliable reception of video data from that camera. Examples of these protocols include ONVIF and PSIA, which promote interoperability among devices from major manufacturers. If a camera uses an unsupported communication protocol, the system can alert the user and facilitate a firmware update to incorporate the required protocol into the NVR's library, thereby expanding its compatibility over time.

In addition to protocol integration, the camera-integration module includes a video codec submodule responsible for converting various video input formats into a standardized format. Cameras from different manufacturers may generate video streams using diverse codecs, resolutions, and frame rates. By transcoding these inputs into a common format, the NVR ensures uniform processing quality and performance, supporting codecs such as H.264, H.265, and MJPEG, among others.

A flexible configuration interface within the camera-integration module further enhances adaptability. Different camera models may require unique parameters, from proprietary communication APIs to specialized resolution and frame rate settings or distinct motion detection parameters. By allowing users to fine-tune these aspects, the NVR facilitates integration of cameras with unusual specifications or from less common brands. This adaptability ensures that the NVR can accommodate a broad array of cameras and continues to function effectively as new camera models and features emerge in the market.

Once the camera-integration module provides a standardized video feed, the system's AI module processes the incoming streams. Because the NVR typically has limited computational resources, the AI module employs numerous techniques to optimize both memory footprint and inference speed. One key strategy is to use pruned and compressed machine learning models. Pruning involves removing weights and connections that do not significantly influence the model's performance, thereby streamlining inference calculations. Additionally, model compression techniques, including sparsification, leverage data about neuron and layer activity to reduce the model's complexity. This can be accomplished by training a standalone model to learn which parts of the original neural network are most critical. The result is a smaller, more efficient representation capable of running rapidly and accurately on the constrained hardware resources of the NVR.

Matrix-based decomposition methods are also employed to further compress the models. Here, large, dense weight matrices are factored into smaller, more manageable matrices. Many of these decomposed matrices are sparse, making them simpler to store and process. In some cases, a low-rank approximation selects only the most significant singular values from the original weight matrix, allowing the model to retain high accuracy while drastically reducing the number of computations. This combination of deep learning compression techniques and matrix-based decomposition can achieve compression rates exceeding 95%, dramatically shrinking model size and accelerating inference speed. With these optimizations, the NVR can run advanced object detection models on multiple camera feeds simultaneously at high frame rates, often exceeding 25 frames per second across more than 16 IP cameras at once.

### The AI Module in the NVR

The AI module in the NVR is designed to generate rich, textual representations of the video content. The module uses a combination of object detection algorithms and large language models (LLMs) to produce descriptive narratives of what is occurring in the video, frame by frame or clip by clip. For instance, upon detecting a vehicle in motion and recognizing it as a red sedan, the AI module not only stores metadata (e.g., object coordinates, velocity, and type) but also employs an LLM to produce a human-readable description such as, “A red sedan is driving into the parking lot.”

To accomplish this, the AI module first applies object detection models to the incoming video stream. These models identify and classify objects (people, vehicles, animals, license plates, etc.), as well as their attributes (color, size, pose) and actions (walking, running, exiting a vehicle, entering a building). As the models detect and track these objects across multiple frames, the AI module accumulates a structured record of recognized entities and events within each time window.

Once a substantial set of recognized objects and events is collected, the AI module invokes an LLM specifically optimized for generating textual summaries from structured data. The LLM processes these object-level annotations and contextual information about their movements, interactions, and temporal ordering. It then composes a coherent narrative that describes the scene. For example, if the video shows multiple individuals entering a building while a car is idling nearby, the LLM might produce a textual summary such as, “Two individuals approach the entrance of the office building at noon, while a red sedan remains parked near the curb.”

After generating this descriptive text, the system refines it into semantically meaningful segments. These segments correspond to self-contained “units of meaning” within the textual narrative. For example, the full narrative might be divided into segments like: (1) “Two individuals approach the entrance of the office building at noon,” and (2) “A red sedan remains parked near the curb.” Each segment encapsulates a distinct event or set of observations and can be aligned with a specific time interval in the source video.

Next, these textual segments are passed through a language embedding model to convert them into high-dimensional vector representations. Such embeddings encode the semantic content of each segment, allowing the system to efficiently store, index, and search for specific events or object types using vector similarity queries. For instance, a user might later submit a natural language query, such as, “Show me clips where people enter the building during lunchtime,” or “Find the moment with a red car parked outside.” The system transforms the user's query into a similar vector representation and compares it against the stored vector embeddings from the segments.

To maintain a clear association between the vector embeddings and their corresponding video content, the system stores a mapping from each embedding vector to the relevant time range of the video. For example, the segment “Two individuals approach the entrance . . . ” might be associated with a 12:00:00-12:00:15 timestamp window. The vector database thus links every semantic vector representation back to the original video portion, enabling precise retrieval of the relevant clips upon a vector similarity search.

The NVR leverages these textual embeddings to enhance its overall functionality. Rather than merely alerting users to predefined events or objects, the system becomes a powerful semantic search engine for video. Combined with the user-configurable AI tasks (e.g., motion detection, facial recognition, or license plate reading) and parallel processing options, this embedding-based semantic indexing capability transforms large volumes of surveillance footage into a flexible, intelligent, and searchable resource. When patterns of increased activity occur-such as multiple motion detections and a proliferation of events-the NVR can spin up additional pruned AI models and text-generation tasks in parallel to keep pace. These processes ensure that even during peak load, detailed semantic descriptions are still generated, embedded, and associated with the correct video intervals, maintaining consistent, high-quality search and analytics capabilities.

### Cloud-Access of the NVR

The NVR includes a cloud-access module designed to efficiently manage the transfer of video clips from an NVR device to cloud storage. The module can be configured with various components and features depending on the implementation.

One basic optimization offered by the cloud-access module is video compression before upload. Users may specify the video resolution to achieve a desired compression ratio, and encryption can also be applied for enhanced security. By adjusting these parameters, the system ensures that video clips are prepared for cloud storage in a secure and bandwidth-efficient manner.

The module may include a local clip management sub-module that maintains a staging area for temporarily holding video clips of interest before they are uploaded. This staging area could employ a priority queue to determine the upload order. Users can configure priorities based on video attributes, such as giving higher priority to clips containing unidentified faces over those with recognized individuals. This prioritization ensures that the most critical or unusual footage is uploaded first, improving the responsiveness and relevance of the system.

To further tackle bandwidth constraints, the cloud-access module can implement a dynamic streaming policy. For example, an initial lower-resolution version of a video clip might be uploaded immediately to the cloud once it's ready, allowing users quick remote access. Later, after peak network usage periods have passed, a higher-resolution version may replace the initial lower-resolution clip. By staggering these uploads, the module ensures immediate availability of the footage while also preserving bandwidth for less congested times, ultimately improving user experience and maintaining resource efficiency.

In addition to real-time cloud uploads, the NVR may support both primary and archive storage systems. Current or recent video footage can reside on local primary storage (such as HDDs, SSDs, or NAS devices) for quick retrieval. As video data ages or once it's securely stored in the cloud, it can be migrated to archive storage. Before transferring older footage to the archive, the video data can be compressed further, reducing its size while retaining essential information. This approach optimizes long-term storage and helps maintain system efficiency and data availability over extended periods.

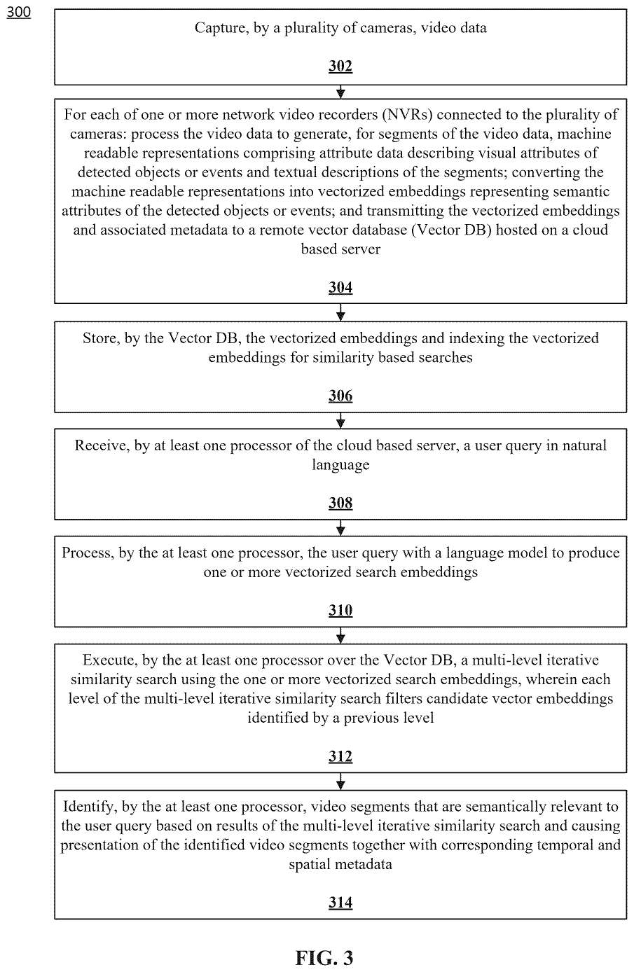

FIG. 3 is a flowchart of an example process 300. In some implementations, one or more blocks of process 300 may be performed by components of a video surveillance system, such as the plurality of cameras, the one or more network video recorders (NVRs), and/or a cloud based server hosting a remote vector database (Vector DB). For example, different blocks may be executed by different processors of the NVRs and the cloud based server, operating together to implement the overall process.

As shown in FIG. 3, process 300 may include capturing, by a plurality of cameras, video data (block 302). For example, the video surveillance system may capture, by the plurality of cameras, video data as described above. As also shown in FIG. 3, process 300 may include, for each of one or more NVRs connected to the plurality of cameras: processing the video data to generate, for segments of the video data, machine-readable representations having attribute data describing visual attributes of detected objects or events and textual descriptions of the segments; converting the machine-readable representations into vectorized embeddings representing semantic attributes of the detected objects or events; and transmitting the vectorized embeddings and associated metadata to a remote Vector DB hosted on a cloud based server (block 304). For example, the video surveillance system may, for each of the one or more NVRs connected to the plurality of cameras, process the video data to generate, for segments of the video data, machine-readable representations having attribute data describing visual attributes of detected objects or events and textual descriptions of the segments, convert the machine-readable representations into vectorized embeddings representing semantic attributes of the detected objects or events, and transmit the vectorized embeddings and associated metadata to the remote Vector DB hosted on the cloud based server, as described above.

As further shown in FIG. 3, process 300 may include storing, by the Vector DB, the vectorized embeddings and indexing the vectorized embeddings for similarity based searches (block 306). For example, the video surveillance system may store, by the Vector DB, the vectorized embeddings and index the vectorized embeddings for similarity based searches, as described above. As also shown in FIG. 3, process 300 may include receiving, by at least one processor of the cloud based server, a user query in natural language (block 308). For example, the video surveillance system may receive, by at least one processor of the cloud based server, a user query in natural language, as described above.

As further shown in FIG. 3, process 300 may include processing, by the at least one processor, the user query with a language model to produce one or more vectorized search embeddings (block 310). For example, the video surveillance system may process, by the at least one processor, the user query with a language model to produce one or more vectorized search embeddings, as described above. As also shown in FIG. 3, process 300 may include executing, by the at least one processor over the Vector DB, a multi-level iterative similarity search using the one or more vectorized search embeddings, where each level of the multi-level iterative similarity search filters candidate vector embeddings identified by a previous level (block 312). For example, the video surveillance system may execute, by the at least one processor over the Vector DB, the multi-level iterative similarity search using the one or more vectorized search embeddings, where each level of the multi-level iterative similarity search filters candidate vector embeddings identified by a previous level, as described above.

As further shown in FIG. 3, process 300 may include identifying, by the at least one processor, video segments that are semantically relevant to the user query based on results of the multi-level iterative similarity search and causing presentation of the identified video segments together with corresponding temporal and spatial metadata (block 314). For example, the video surveillance system may identify, by the at least one processor, video segments that are semantically relevant to the user query based on results of the multi-level iterative similarity search and cause presentation of the identified video segments together with corresponding temporal and spatial metadata, as described above.

Process 300 may include additional implementations, such as any single implementation or any combination of implementations described below and/or in connection with one or more other processes described elsewhere herein. In a first implementation, processing the user query with the language model may include: decomposing the user query into a plurality of semantic components including at least an object type component and an attribute component; and generating separate vectorized search embeddings corresponding to each of the plurality of semantic components.

In a second implementation, alone or in combination with the first implementation, executing the multi-level iterative similarity search may include: in a first level, identifying a first candidate set of vector embeddings associated with the object type component; and in at least one subsequent level, restricting similarity search to the first candidate set and filtering the first candidate set based on the attribute component to obtain a refined candidate set.

Although FIG. 3 shows example blocks of process 300, in some implementations, process 300 may include additional blocks, fewer blocks, different blocks, or differently arranged blocks than those depicted in FIG. 3. Additionally or alternatively, two or more of the blocks of process 300 may be performed in parallel.

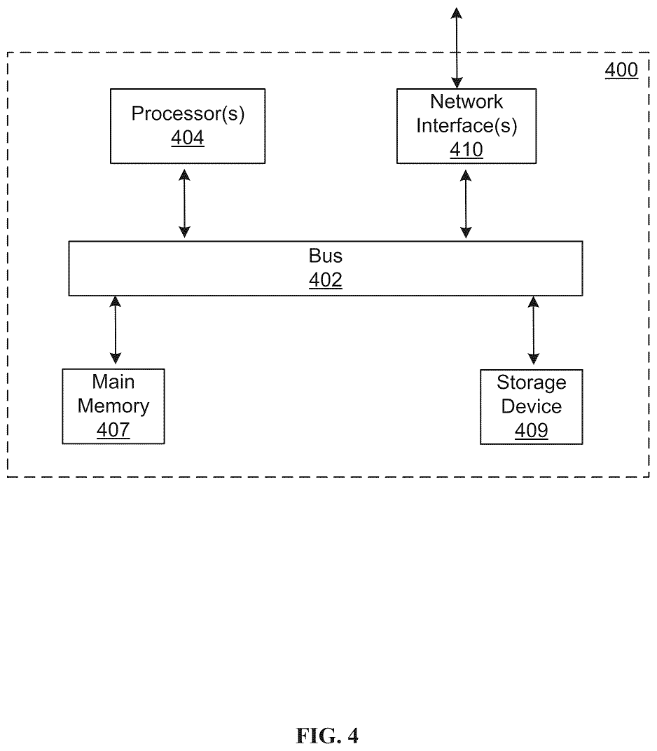

FIG. 4 illustrates an example computer system in which any of the embodiments described herein may be implemented. The computing device may be used to implement one or more components of the systems and the methods shown in FIGS. 1A-3. The computing device 400 may comprise a bus 402 or other communication mechanisms for communicating information and one or more hardware processors 404 coupled with bus 402 for processing information. Hardware processor(s) 404 may be, for example, one or more general-purpose microprocessors.

The computing device 400 may also include a main memory 407, such as random-access memory (RAM), cache and/or other dynamic storage devices, coupled to bus 402 for storing information and instructions to be executed by processor(s) 404. Main memory 407 may also be used for storing temporary variables or other intermediate information during the execution of instructions to be executed by processor(s) 404. Such instructions, when stored in storage media accessible to processor(s) 404, may render computing device 400 into a special-purpose machine that is customized to perform the operations specified in the instructions. Main memory 407 may include non-volatile media and/or volatile media. Non-volatile media may include, for example, optical or magnetic disks. Volatile media may include dynamic memory.

Common forms of media may include, for example, a floppy disk, a flexible disk, a hard disk, a solid-state drive, a magnetic tape, or any other magnetic data storage medium, a CD-ROM, any other optical data storage medium, any physical medium with patterns of holes, a RAM, a DRAM, a PROM, an EPROM, a FLASH-EPROM, NVRAM, any other memory chip or cartridge, or networked versions of the same.

The computing device 400 may implement the techniques described herein using customized hard-wired logic, one or more ASICs or FPGAs, firmware and/or program logic which in combination with the computing device may cause or program computing device 400 to be a special-purpose machine. According to one embodiment, the techniques herein are performed by computing device 400 in response to processor(s) 404 executing one or more sequences of one or more instructions contained in main memory 407. Such instructions may be read into main memory 407 from another storage medium, such as storage device 409. Execution of the sequences of instructions contained in main memory 407 may cause processor(s) 404 to perform the process steps described herein. For example, the processes/methods disclosed herein may be implemented by computer program instructions stored in main memory 407. When these instructions are executed by processor(s) 404, they may perform the steps as shown in corresponding figures and described above. In alternative embodiments, hard-wired circuitry may be used in place of or in combination with software instructions.

The computing device 400 also includes a communication interface 410 coupled to bus 402. Communication interface 410 may provide a two-way data communication coupling to one or more network links that are connected to one or more networks. As another example, communication interface 410 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be composed in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A video surveillance system comprising:
a plurality of cameras for capturing video data;
one or more network video recorders (NVRs) connected to the plurality of cameras, each NVR configured to:
process the video data to generate, for segments of the video data, machine-readable representations comprising attribute data describing visual attributes of detected objects or events and textual descriptions of the segments;
convert the machine-readable representations into vectorized embeddings representing semantic attributes of detected objects or events; and
transmit the vectorized embeddings and associated metadata to a remote vector database (Vector DB);
a cloud-based server hosting the remote Vector DB, wherein the Vector DB is configured to store, index, and retrieve vectorized embeddings for similarity-based searches; and
at least one processor of the cloud-based server is configured to:
receive a user query in natural language;
process the user query with a language model to produce one or more vectorized search embeddings;
execute, over the remote Vector DB, a multi-level iterative similarity search using the one or more vectorized search embeddings, wherein each level of the multi-level iterative similarity search filters candidate vector embeddings identified by a previous level; and
identify video segments that are semantically relevant to the user query based on results of the multi-level iterative similarity search and cause presentation of the identified video segments together with corresponding temporal and spatial metadata.

2. The video surveillance system of claim 1, wherein the textual descriptions of the segments are generated by a language model based on the attribute data describing the visual attributes of the detected objects or the events.

3. The video surveillance system of claim 2, wherein each NVR is further configured to:
segment the textual descriptions into a plurality of semantically distinct textual segments, and
convert each of the plurality of semantically distinct textual segments into a corresponding vectorized embedding associated with a respective temporal interval of the video data.

4. The video surveillance system of claim 1, wherein the vectorized embeddings transmitted to the remote Vector DB comprise:
object level embeddings derived directly from detected visual attributes, and
text derived embeddings derived from the textual descriptions,
the object level embeddings and the text derived embeddings being stored in a common semantic vector space.

5. The video surveillance system of claim 1, wherein to process the user query with the language model, the at least one processor is configured to:
decompose the user query into a plurality of semantic components including at least an object type component and an attribute component, and
generate separate vectorized search embeddings corresponding to each of the plurality of semantic components.

6. The video surveillance system of claim 5, wherein to execute the multi-level iterative similarity search, the at least one processor is configured to:
in a first level, identify a first candidate set of vector embeddings associated with the object type component; and
in at least one subsequent level, restrict similarity search to the first candidate set and filter the first candidate set based on the attribute component to obtain a refined candidate set.

7. The video surveillance system of claim 5, wherein the plurality of semantic components further comprise one or more temporal or location components, and
wherein at least one level of the multi-level iterative similarity search applies a time based or location based filter using metadata associated with the vector embeddings.

8. The video surveillance system of claim 1, wherein the at least one processor of the cloud based server is further configured to:
apply a time based ordering over the results of the multi-level iterative similarity search and
select a most recent video segment satisfying a temporal condition expressed in the user query.

9. The video surveillance system of claim 1, wherein the at least one processor of the cloud based server is further configured to:
cause presentation of a map view that displays locations associated with the identified video segments based on spatial metadata stored together with the vectorized embeddings.

10. The video surveillance system of claim 9, wherein the at least one processor of the cloud based server is configured to:
render a trajectory of a detected object across multiple locations by linking spatial metadata and temporal metadata of the identified video segments associated with the detected object.

11. The video surveillance system of claim 9, wherein a user selecting one of the identified video segment causes the at least one processor to highlight, in the map view, a camera location corresponding to the user-selected video segment.

12. The video surveillance system of claim 1, wherein receiving the user query in natural language comprises receiving at least one of:
a textual query entered through a user interface;
a spoken query captured as an audio signal and converted into text; and
an image uploaded as a reference image, and
wherein the language model and a vision model are configured to jointly convert the user query into the one or more vectorized search embeddings.

13. The video surveillance system of claim 1, wherein the at least one processor of the cloud based server is further configured to:
receive a user defined alert condition expressed in natural language;
convert the user defined alert condition into one or more alert embeddings;
periodically compare, according to a scheduled task, newly received vectorized embeddings from the NVRs against the alert embeddings; and
in response to detecting a similarity exceeding a threshold, initiate transmission of an alert notification to a client device.

14. The video surveillance system of claim 1, wherein each NVR further comprises a configuration user interface through which a user defines objects and alert conditions in natural language, the NVR being configured to:
interpret the user-defined objects and alert conditions into a combination of underlying object detection and action recognition tasks;
generate one or more embeddings representing the user-defined objects and alert conditions; and
compare embeddings derived from processed video segments against the embeddings representing the user-defined objects and alert conditions to locally determine whether a segment satisfies the user-defined condition.

15. The video surveillance system of claim 14, wherein the user-defined objects and alert conditions comprise a composite scenario involving at least a human, an action, and a target object, and the NVR is configured to:
generate embeddings for textual descriptions of video segments that describe the composite scenario, and
determine that a similarity between the embeddings for the textual descriptions and the embeddings representing the user-defined objects and alert conditions exceeds a similarity threshold.

16. The video surveillance system of claim 1, further comprising a cluster level load balancing service configured to:
receive telemetry from the one or more NVRs, the telemetry comprising at least one of frame processing latency, accelerator utilization, memory usage, number of active camera streams, or scene complexity based on detected object density, and
dynamically assign camera streams among the NVRs based at least in part on the received telemetry.

17. A computer implemented method for video surveillance, comprising:
capturing, by a plurality of cameras, video data;
for each of one or more network video recorders (NVRs) connected to the plurality of cameras:
processing the video data to generate, for segments of the video data, machine readable representations comprising attribute data describing visual attributes of detected objects or events and textual descriptions of the segments;
converting the machine readable representations into vectorized embeddings representing semantic attributes of the detected objects or events; and
transmitting the vectorized embeddings and associated metadata to a remote vector database (Vector DB) hosted on a cloud based server;
storing, by the Vector DB, the vectorized embeddings and indexing the vectorized embeddings for similarity based searches;
receiving, by at least one processor of the cloud based server, a user query in natural language;
processing, by the at least one processor, the user query with a language model to produce one or more vectorized search embeddings;
executing, by the at least one processor over the Vector DB, a multi-level iterative similarity search using the one or more vectorized search embeddings, wherein each level of the multi-level iterative similarity search filters candidate vector embeddings identified by a previous level; and
identifying, by the at least one processor, video segments that are semantically relevant to the user query based on results of the multi-level iterative similarity search and causing presentation of the identified video segments together with corresponding temporal and spatial metadata.

18. The method of claim 17, wherein processing the user query with the language model comprises:
decomposing the user query into a plurality of semantic components including at least an object type component and an attribute component; and
generating separate vectorized search embeddings corresponding to each of the plurality of semantic components.

19. The method of claim 18, wherein executing the multi-level iterative similarity search comprises:
in a first level, identifying a first candidate set of vector embeddings associated with the object type component; and
in at least one subsequent level, restricting similarity search to the first candidate set and filtering the first candidate set based on the attribute component to obtain a refined candidate set.

20. A non-transitory computer readable medium storing instructions that, when executed by one or more processors of a video surveillance system comprising a plurality of cameras, one or more network video recorders (NVRs), and a cloud-based server hosting a remote vector database (Vector DB), cause the one or more processors to perform operations comprising:
receiving, at the one or more NVRs, captured video data from the plurality of cameras;
for each of the one or more NVRs:
processing the video data to generate, for segments of the video data, machine readable representations comprising attribute data describing visual attributes of detected objects or events and textual descriptions of the segments;
converting the machine readable representations into vectorized embeddings representing semantic attributes of the detected objects or events; and
transmitting the vectorized embeddings and associated metadata to the remote Vector DB hosted on the cloud-based server;
storing, by the Vector DB, the vectorized embeddings and indexing the vectorized embeddings for similarity based searches;
receiving, by at least one processor of the cloud-based server, a user query in natural language;
processing, by the at least one processor of the cloud-based server, the user query with a language model to produce one or more vectorized search embeddings;
executing, by the at least one processor of the cloud-based server over the Vector DB, a multi-level iterative similarity search using the one or more vectorized search embeddings, wherein each level of the multi-level iterative similarity search filters candidate vector embeddings identified by a previous level; and
identifying, by the at least one processor of the cloud-based server, video segments that are semantically relevant to the user query based on results of the multi-level iterative similarity search and causing presentation of the identified video segments together with corresponding temporal and spatial metadata.
